(19) United States
(12) Patent Application Publication
(10) Pub. No.: US 2016/0169399 A1
(43) Pub. Date: Jun. 16, 2016

(54) GAS SHUT-OFF VALVE WITH THERMAL SAFETY

(71) Applicant: COPRECITEC, S.L., Aretxabaleta (ES)

(72) Inventor: Felix QUEREJETA ANDUEZA, Hendaye (FR)

(21) Appl. No.: 14/951,853

(22) PCT Filed: May 22, 2014
(86) PCT No.: PCT/EP2014/060498

§ 371 Date: Nov. 25, 2015

(30) Foreign Application Priority Data
May 29, 2013 (ES) U 201330662

(51) Int. Cl. F16K 17/38; F23N 1/00; F23N 5/24; F16K 31/08

(52) U.S. Cl. CPC F16K 17/38; F16K 31/084; F23N 1/00; F23N 5/24; F23N 2035/24; F23N 2035/22

(57) ABSTRACT

Gas shut-off valve with thermal safety comprising a gas inlet, a gas outlet, a body comprising the inlet and the outlet and defining an intermediate opening between the inlet and the outlet, and a shut-off element. The body comprises a housing arranged on the intermediate opening, the shut-off element being arranged in the housing and the valve comprising a cover arranged on the housing and attached to the body, a ferromagnetic element arranged in the housing fixed to the shut-off element and comprising a predetermined Curie temperature, a spring associated with the shut-off element and with the cover, and a permanent magnet attached to the cover. The ferromagnetic element is arranged between the permanent magnet and the shut-off element.

### CROSS-REFERENCE TO RELATED APPLICATIONS

This application relates to and claims the benefit and priority to International Application No. PCT/EP2014/060498, filed May 22, 2014, which claims the benefit and priority to Spanish Application No. U 201330662, filed May 29, 2013.

### TECHNICAL FIELD

The present invention relates to gas shut-off valves with thermal safety.

### BACKGROUND

Gas valves are widely known and used. Gas valves serve to allow, prevent or regulate the passage of gas from one point (inlet) to another point (outlet). Valves that acquire two positions, i.e., open and closed positions, are commonly known as shut-off valves.

There are different types of shut-off valves. Some of them are shut-off valves that open or close depending on electric signals, for example. These include ON-OFF type shut-off valves where a coil is powered for opening the valve and it remains open as long as the coil is being powered, and flip-flop type shut-off valves where the valve is opened by providing a current pulse to the power supply but continuous power supply is not needed to keep the valve open, a current pulse opposite the first pulse being applied for closing said valve.

Valves using permanent magnets and elements with ferromagnetic properties for maintaining a state of the valve are known. As a result of the ferromagnetic properties of the element and the magnetic field of the permanent magnet, said element remains adhered to the permanent magnet, thus maintaining the state of the valve. When a specific temperature is exceeded, the element loses its ferromagnetic properties and no longer adheres to the permanent magnet. This temperature where the element loses its ferromagnetic properties is known as the Curie temperature.

Document GB 1485215 discloses a gas shut-off valve that is usually closed and opens when a specific temperature in its surrounding areas is exceeded. The valve comprises a permanent magnet and a heat sensing element having a Curie temperature equal to or greater than a gas ignition temperature, such that the heat sensing element loses its ferromagnetic properties when the temperature exceeds said value and is separated from the permanent magnet, the valve being opened. Therefore, the valve only opens once a specific temperature, which corresponds with the flame ignition temperature, has been exceeded and it can also be used as a flame detector.

### SUMMARY OF THE DISCLOSURE

The safety gas shut-off valve comprises a gas inlet, a gas outlet, an intermediate opening between the inlet and the outlet, and a shut-off element which blocks or closes the intermediate opening in a shut-off position, preventing the passage of gas from the inlet to the outlet, and allows said passage in an open position.

According to one implementation the valve further comprises a cover, a ferromagnetic element which is fixed to the shut-off element and comprises a specific Curie temperature, a spring associated with the shut-off element through a first end and with the cover through a second end, and a permanent magnet attached to the cover. As a result of the ferromagnetic properties of the ferromagnetic element and the magnetic field generated by the permanent magnet, said ferromagnetic element adheres to the permanent magnet, the intermediate opening being open, and the valve therefore being open. When a specific temperature which corresponds with the specific Curie temperature for the ferromagnetic element is reached, the ferromagnetic element loses its ferromagnetic properties and due to the action of the spring, said ferromagnetic element is separated from the permanent magnet and the shut-off element closes the intermediate opening, the valve being closed.

The valve allows uses other than those which are common in gas shut-off valves, such as the use thereof as a safety device to prevent something worse from happening in the event of fire or unwanted blazes, for example.

The configuration of the valve of the invention and the arrangement of its elements gives rise to obtaining a valve in an easy, simple and compact manner fulfilling the function of closing automatically in response to adverse conditions such as fire or unwanted flame in the proximities of the actual valve, for example; in summary, a valve that closes automatically when unwanted temperatures are reached in its surrounding areas is achieved.

Therefore, as a safety measure in response to fire, this valve can be arranged in the entrance of a house, of the kitchen or of the room where gas is used, such that if fire is detected, said valve will automatically cut off the gas supply to the house, kitchen or room and stop further feeding the fire. As a safety measure in response to an unwanted flame such as when oil in a frying pan catches fire, for example, this valve can be arranged above the burners where the frying pan is arranged (in a hood, for example, if there is one), such that in response to the presence of the unwanted blaze in the frying pan, the valve would close, cutting off the passage of gas to the burner that heats the flame. These examples are merely illustrative and in no case limiting, since the valve can also be used in ovens and cooktops, for example, and in the outlets of butane cylinders to prevent gas from seeping out of the cylinders when the temperature in the surrounding area of the valve exceeds a specific value.

These and other advantages and features will become evident in view of the drawings and the detailed description.

### BRIEF DESCRIPTION OF THE DRAWINGS

FIG. 1 shows a perspective view of an embodiment of the gas shut-off valve with thermal safety.

FIG. 2 is a cross-section view of the body of the valve of FIG. 1.

FIG. 3 is a cross-section view of the valve of FIG. 1, wherein said valve is open.

FIG. 4 is a cross-section view of the valve of FIG. 1, wherein said valve is closed.

FIG. 5 is a cross-section view of the valve of FIG. 1, wherein said valve is open and the manual actuator is in position for opening the valve.

### DETAILED DESCRIPTION

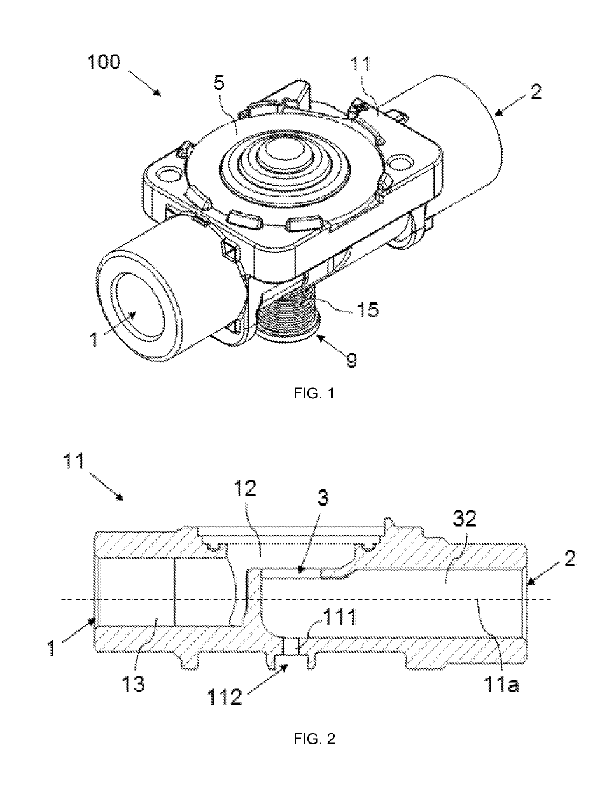

FIG. 1 shows by way of example an embodiment of the gas shut-off valve 100 with thermal safety of the invention. The valve 100 comprises a body 11 shown by way of example in FIG. 2, comprising a gas inlet 1, a gas outlet 2, an intermediate opening 3 between the inlet 1 and the outlet 2, an inlet conduit 13 extending from the inlet 1 to the intermediate opening 3 and an outlet conduit 32 extending from the intermediate opening 3 to the outlet 2. The body 11 comprises a longitudinal axis 11a and the intermediate opening 3 may be substantially parallel to said longitudinal axis 11a. In the embodiment shown in the drawings, the conduits 13 and 32 extend longitudinally.

The body 11 further comprises a housing 12 which is arranged between the inlet conduit 13 and the intermediate opening 3 and on the intermediate opening 3. The housing 12 serves for housing the elements of the valve 100 which work together for opening or closing the valve 100 and which will be explained below. To facilitate the assembly of the valve 100, particularly to facilitate the insertion of said elements in the housing 12, said housing 12 is accessible from outside the body 11. For the operation of the valve 100, the housing 12 stops being accessible from the outside, and to that end the valve 100 comprises a cover 5 and at least one sealing element 17 between the cover 5 and the body 11 to prevent gas inside the valve 100 from leaking out through the areas of attachment between the cover 5 and the body 11.

The valve 100 comprises a shut-off element 4 which has a specific profile suitable for being able to block or close the intermediate opening 3 when required, housed in the housing 12 and suitable for closing the intermediate opening 3 in a shut-off position and preventing communication between the inlet 1 and the outlet 2, and therefore preventing gas from being able to reach the outlet 2 from the inlet 1, not preventing said communication in an open position. In the embodiment shown in the drawings, the shut-off element 4 is suitable for moving transversely with respect to the longitudinal axis 11a of the body 11 for changing position. The shut-off element 4 has a specific profile which is suitable for closing the intermediate opening 3 when required.

The valve 100 comprises a ferromagnetic element 6 which is arranged in the housing 12 fixed to the shut-off element 4, moving integrally with it and comprising a specific Curie temperature that depends on what is required, as will be explained below. The valve 100 further comprises in the housing 12 a spring 7 associated with the shut-off element 4 through a first end and with the cover 5 through a second end, and a static permanent magnet 8. In one embodiment, the permanent magnet 8 is attached to the cover 5, and to facilitate this attachment the cover 5 is made of a ferromagnetic material such that the cover 5 and the permanent magnet 8 are attached to one another as a result of the permanent magnetic field generated by the permanent magnet 8. In other embodiments, it is also possible to use other types of attachments to attach the cover 5 and the permanent magnet 8 to one another. The ferromagnetic element 6 is arranged between the shut-off element 4 and the permanent magnet 8.

According to one implementation the shut-off element 4 is an element of revolution comprising two concentric sections arranged one after another. A first section comprises a smaller radius but a greater length than a second section. The first section is covered by the ferromagnetic element 6, and the second end of the spring 7 is associated with the second section of the shut-off element 4. In the embodiment shown in the drawings, the spring 7 is supported on the second section of the shut-off element 4 but it may be attached to said second section.

In the embodiment shown in the drawings, the sealing element 17 and the shut-off element 4 are part of one and the same element that corresponds with a membrane 40. Therefore, the functions of sealing (a function of the sealing element 17) and closing the valve 100 (a function of the shut-off element 4) are performed with a single element (membrane 40), which facilitates the manufacture and assembly of the valve 100. The membrane 40 is arranged in the housing 12 of the body 11 of the valve 100 and is manufactured from an elastomer material, the part of the membrane 40 connecting the sealing element 17 and the shut-off element 4 being flexible. A space where the ferromagnetic element 6, the spring 7 and the permanent magnet 8 are arranged is defined between the cover 5 and the membrane 40. In other embodiments relating to the embodiment shown in the drawings, the sealing element 17 and the shut-off element 4 can be two independent elements.

The operation of the valve 100 is explained below.

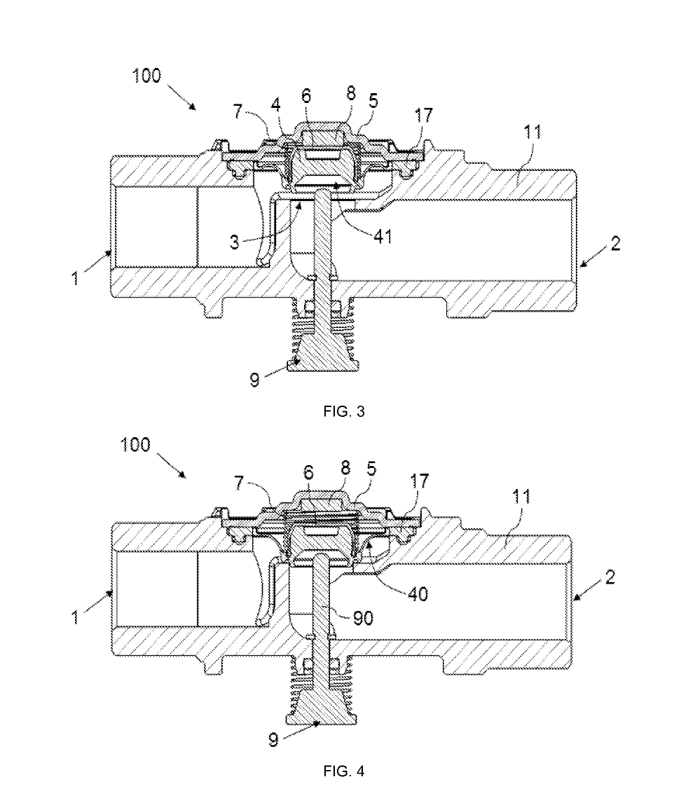

When the valve 100 is open, the permanent magnetic field generated by the permanent magnet 8 causes the ferromagnetic element 6 to adhere to the permanent magnet 8, as shown in FIG. 3. The height of the shut-off element 4 is less than the distance between the intermediate opening 3 and the permanent magnet 8, such that when the ferromagnetic element 6 adheres to the permanent magnet 8, since the shut-off element 4 and the ferromagnetic element 6 are attached to one another, there is a free space between the intermediate opening 3 and the shut-off element 4 which is used by the gas to go from the inlet conduit 13 to the outlet conduit 32, and therefore to go from the inlet 1 to the outlet 2. In this situation the valve 100 is open.

The spring 7 is sized and configured such that when the valve 100 is open the spring 7 is compressed. When the surrounding area of the valve 100 exceeds the predetermined Curie temperature of the ferromagnetic element 6, the ferromagnetic element 6 loses its ferromagnetic properties and is no longer attracted by the permanent magnet 8. In this situation, the force of the compressed spring 7 does not withstand any counteracting force and the spring 7 expands to recover its standby shape, causing the shut-off element 4 which is associated with the second end of the spring 7 to move towards the intermediate opening 3, closing it. The ferromagnetic element 6 moves integrally with the shut-off element 4, being separated from the permanent magnet 8. In this situation, the valve 100 is closed and the spring 7 is in standby, as shown in FIG. 4. The Curie temperature is selected depending on the temperature in the surrounding area of the valve 100 starting from which passage of gas through the valve 100 is to be prevented, such that the valve 100 acts as a thermal safety device. In one embodiment, the Curie temperature is within a range defined between about 90° C. and about 130° C., such that the valve 100 closes when there is a fire or a flame in its surrounding area. The temperature inside the valve 100 and in its surrounding area is generally virtually the same.

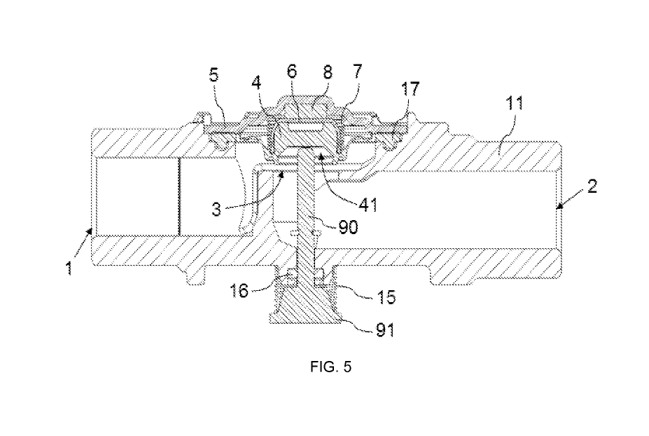

In the embodiment shown in the drawings, the valve 100 comprises a manual actuator 9 for manually opening same. The valve 100 can thus be opened manually, such action being depicted in FIG. 5, either before the first use or after having been close for safety reasons. The manual actuator 9 is accessible from outside so that a user can act on it, but it goes into the valve 100 to move the ferromagnetic element 6 closer to the permanent magnet 8, so that the permanent magnetic field attracts the ferromagnetic element 6 and keeps it attracted. The shut-off element 4 is fixed to the ferromagnetic element 6 such that the valve 100 is opened.

The body 11 comprises a through hole 111 communicating the inside of the valve 100 with the outside of the valve 100, and the manual actuator 9 comprises a rod 90 passing through the through hole 111. The valve 100 comprises a sealing element 16 to prevent gas inside the valve 100 from leaking out due to the through hole 111, and to that end the body 11 comprises a housing 112 where the sealing element 16, which corresponds to an O-ring, is arranged. In the embodiment shown in the drawings, the housing 112 is arranged outside the valve 100, although in other embodiments relating to this embodiment, the housing can be arranged inside the valve 100.

The rod 90 comprises a first zone inside the body 11, particularly in the outlet conduit 32, and a second zone outside the body 11. A first end of the rod 90, belonging to the first zone, is facing the shut-off element 4, and a second end of the rod 90, belonging to the second zone, is accessible for a user. The valve 100 comprises a spring element 15 which is arranged outside the body 11 and associated with the second end of the rod 90. Said second end comprises a seat 91, and the spring element 15 is attached to said seat 91 through a first end and associated with the body 11 through a second end opposite said first end. In the embodiment shown in the drawings, the spring element 15 is supported on the seat 91 of the rod 90 but it may be attached to said seat 91. The second zone of the rod 90 goes through the spring element 15.

When a user acts on the manual actuator 9 for opening the valve 100, the rod 90 is moved towards the shut-off element 4, pushing it. The rod 90 is aligned with the shut-off element 4 and is moved in alignment with said shut-off element 4, transverse to the longitudinal axis 11a of the body 11. In the embodiment shown in the drawings, the shut-off element 4 comprises a housing 41 to facilitate the actuation of the rod 90 thereon, although it may not have said housing 41. As the shut-off element 4 pushed by the rod 90 moves, the ferromagnetic element 6 also moves and adheres to the permanent magnet 8, the valve 100 remaining open even when the shut-off element 4 is no longer being pushed (provided that the temperature in the surrounding area of the valve 100 is less than the predetermined Curie temperature). When the user stops acting on the manual actuator 9, the spring recovers its standby position, forcing the rod 90 to return to its initial position. Therefore, when the temperature in the surrounding area of the valve 100 reaches the Curie temperature, the valve 100 can be closed because if the rod 90 does not return to its position, said rod would prevent the movement of the shut-off element 4 for closing the intermediate opening 3.

In other embodiments that are not depicted in the drawings, the valve 100 is similar to that of the drawings but it neither comprises nor is it associated with the manual actuator 9 (spring element 15, through hole 111, housing 112, O-ring 16).

What is claimed is:

1. A shut-off valve comprising:
a body having a first housing,
a gas inlet conduit,
a gas outlet conduit,
an opening in the valve body that communicates the gas inlet conduit with the gas outlet conduit,
a shut-off element located in the first housing and moveable between an open position and a closed position, in the open position the shut-off element is positioned to permit the gas inlet conduit to communicate with the gas outlet conduit, in the closed position the shut-off element is positioned to prevent the gas inlet conduit to communicate with the gas outlet conduit, the shut-off element having a first side that faces the opening and a second side opposite the first side,
a first spring that functions to continuously urge the shut-off element toward the closed position,
a cover attached to the body,
a static permanent magnet located in the cover,
a ferromagnetic element coupled to the second side of the shut-off element and being located between the shut-off element and the permanent magnet, when the shut-off element is in the open position the ferromagnetic element is positioned nearer the static permanent magnet than when the shut-off element is in the closed position, the ferromagnetic element comprising a Curie point metal, the ferromagnetic property of the ferromagnetic element being diminished upon the temperature of the ferromagnetic element reaching a predetermined Curie point temperature, when the shut-off element is in the closed position and the ferromagnetic element is below the predetermined Curie point temperature the magnetic field of the static permanent magnet is insufficient to attract and move the ferromagnetic element to cause the shut-off element to assume the open position, when the shut-off element is in the open position and the ferromagnetic element is below the predetermined Curie point temperature the shut-off valve is maintained in the open position, when the shut-off element is in the open position and the ferromagnetic element reaches the predetermined Curie point temperature the shut-off element is moved to the closed position by the action of the spring.

2. The shut-off valve according to claim 1, wherein the ferromagnetic element is fixed directly to the second side of the shut-off element.

3. The shut-off valve according to claim 1, wherein the shut-off element passes through a portion of the first spring.

4. The shut-off valve according to claim 1, wherein the shut-off element is associated with a central section of a membrane, the membrane including a peripheral section that extends outward from the central section.

5. The shut-off valve according to claim 4, wherein the shut-off element passes through a portion of the first spring.

6. The shut-off element according to claim 5, wherein the first spring acts on the peripheral section of the membrane.

7. The shut-off element according to claim 6, wherein the first spring is supported on the peripheral section of the membrane.

8. The shut-off valve according to claim 4, further comprising a sealing element arranged between the cover and body, the sealing element forming a part of the membrane.

9. The shut-off valve according to claim 8, wherein a part of the membrane situated between the shut-off element and sealing element is flexible.

10. The shut-off valve according to claim 4, wherein the static permanent magnet, first spring and ferromagnetic element are disposed between the cover and the membrane.

11. The shut-off valve according to claim 1, further comprising a manual actuator moveable between a first position and a second position, the manual actuator having a first part located external to the body and a second part located internal to the body, the second part configured to act on the first side of the shut-off element, when the manual actuator is in the first position the second part is spaced away from the shut-off element and does not interfere with the movement of the shut-off element, when the manual actuator is moved from the first position to the second position the second part acts on the first side of the shut-off element to cause the shut-off element to assume the open position.

12. The shut-off valve according to claim 11, further comprising a second spring that continuously urges the manual actuator toward the first position.

13. The shut-off valve according to claim 11, wherein the second part of the manual actuator comprises a rod, the body having a through hole through which the rod passes.

14. The shut-off valve according to claim 12, wherein the first part of the manual actuator comprises a seat onto which an end of the second spring acts to urge the manual actuator to toward the first position.

15. The shut-off valve according to claim 14, wherein the second spring envelops a part of the rod.

16. The shut-off valve according to claim 13, further comprising a second housing through which the rod passes, arranged in the housing is a second sealing element that surrounds the rod to provide a fluid tight seal between the body of the shut-off valve and the external environment.

17. The shut-off valve according to claim 16, wherein the second housing is located outside the body.

18. The shut-off valve according to claim 1, wherein the predetermined Curie point temperature of the ferromagnetic element is between 90° C. and 130° C.

19. The shut-off valve according to claim 1, wherein the cover is made of a ferromagnetic material.

20. The shut-off valve according to claim 19, wherein the static permanent magnet is only magnetically attached to the cover.

21. The shut-off valve according to claim 1, wherein when the shut-off element is in the closed position it is only moveable to the open position by the use of a manual actuator that extends externally to the body.
